(19) United States
(12) Patent Application Publication
(10) Pub. No.: US 2023/0153384 A1
(43) Pub. Date: May 18, 2023

(54) TRAINING CLASSIFICATION MODEL FOR AN AUTONOMOUS VEHICLE BY USING AN AUGMENTED SCENE

(71) Applicant: GM Cruise Holdings LLC, San Francisco, CA (US)

(72) Inventors: Richard Stenson, Miami, FL (US); Ignacio Martin-Bragado, Mountain View, CA (US); Yibo Zhang, San Francisco, CA (US)

(73) Assignee: GM Cruise Holdings LLC, San Francisco, CA (US)

(21) Appl. No.: 17/522,096

(22) Filed: Nov. 9, 2021

(51) Int. Cl. G06K 9/62; G06K 9/00

(52) U.S. Cl. CPC G06K 9/6256; G06K 9/00791

(57) ABSTRACT

A classification model can be trained by using an augmented scene. The augmented scene may be generated by placing augmentation objects into a simulated scene that is a virtual representation of a real-world scene. The augmentation objects are virtual objects representing a category for which a reference classification model has a poor performance. The reference classification model may be a simulated model trained by using a simulated scene or a real-world model trained by using a real-world scene. A training set, which includes simulated sensor data of the augmentation objects and labels of the augmentation objects, can be used to train the augmented model. The augmented model can be used by an AV to classify objects in the surrounding environment of the AV. The augmented model can have a better accuracy in classifying objects in the category than the reference classification model.

### TECHNICAL FIELD OF THE DISCLOSURE

The present disclosure relates generally to autonomous vehicles (AVs) and, more specifically, to systems and methods for training classification models for AVs by using augmented scenes.

### BACKGROUND

An AV may be a vehicle that may be capable of sensing and navigating its environment with little or no user input. An autonomous vehicle may sense its environment using sensing devices, such as Radio Detection and Ranging (RADAR), Light Detection and Ranging (LIDAR), image sensors, cameras, and the like. An autonomous vehicle system may also use information from a global positioning system (GPS), navigation systems, vehicle-to-vehicle communication, vehicle-to-infrastructure technology, and/or drive-by-wire systems to navigate the vehicle. As used herein, the phrase “autonomous vehicle” may include both fully autonomous and semi-autonomous vehicles.

### BRIEF DESCRIPTION OF THE DRAWINGS

To provide a more complete understanding of the present disclosure and features and advantages thereof, reference may be made to the following description, taken in conjunction with the accompanying figures, wherein like reference numerals represent like parts, in which:

FIG. 1 shows an AV environment according to some embodiments of the present disclosure;

FIG. 2 is a block diagram illustrating an onboard controller of an AV according to some embodiments of the present disclosure;

FIG. 3A is a block diagram illustrating an online system according to some embodiments of the present disclosure;

FIG. 3B is a block diagram illustrating a model trainer of the online system according to some embodiments of the present disclosure;

FIG. 4 illustrates a simulated scene according to some embodiments of the present disclosure;

FIG. 5 illustrates an augmented scene generated based on the simulated scene in FIG. 4 according to some embodiments of the present disclosure; and

FIG. 6 is a flowchart showing a method of training an augmented model according to some embodiments of the present disclosure.

### DESCRIPTION OF EXAMPLE EMBODIMENTS OF THE DISCLOSURE

Overview

In many autonomous driving systems, object identification can be one of the most important prerequisites to autonomous navigation. Object identification may include classifying objects in the surrounding environment of the vehicle, e.g., determining categories of the objects. Object identification can allow the vehicle controller to account for obstacles when considering possible future trajectories. The accuracy of object identification algorithms can be very important to the operation of the vehicle as well as safety within the surrounding environment, e.g., safety of people in the vicinity of the vehicle. Machine learning technology has been used to train classification models used by AVs to identify and classify objects. However, it can be challenging to develop classification models with good accuracy. For instance, there may not be sufficient data to train an accurate classification model. Training data may be collected by navigating AVs on public or private streets. However, it can be difficult to collect enough data this way for various reasons, such as the requirement for licenses, capabilities of the AVs, safety concerns, high costs, and so on. Also, the traffic conditions of different locations can be different, which present an unpredictable sets of objects. Accordingly, a classification model accurate for one location may not be accurate for a different location based on different sets of objects at each location. Some classification models have been trained by using virtual scenes simulating real-world scenes to solve this problem. However, these virtual scenes are limited to the objects that are present in the real-world scenes and fail to provide data for training classification models that can accurately classify objects underrepresented in the real-world scene. Thus, these classification models tend to have low accuracy in classifying objects in certain categories.

A method of training AV classification models by using augmented scenes disclosed herein can overcome these problems. An augmented scene may include a simulated scene and an augmentation object. The simulated scene may be a virtual representation of a real-world scene and may include virtual objects representing real-world objects in the real-world scene. The real-world scene may be a real-world place, e.g., an area where a real AV can navigate. The simulated scene may be a two- or three-dimensional graphical representation of the real-world scene. The simulated scene may also include a simulated AV, which is a virtual representation of a real AV and that can navigate in the simulated scene. The simulated scene may further include simulated sensor data, e.g., sensor data generated by an onboard sensor suite of the simulated AV from the detection of the surrounding environment of the simulated AV. The augmentation object may be a virtual object representing a category for which a reference classification model has poor performance. The category may be underrepresented in the real-world scene, which causes a classification model trained by using the real-world scene to fail to accurately identify objects in the category. For instance, the real-world scene may include no objects in the category or a small number of objects in the category. As another example, even though the real-world scene includes objects in the category, an AV navigating in the real-world scene cannot detect enough of these objects, e.g., due to a limited number of objects in the real-world scene or limited attributes shown by the objects in the real-world scene, so that the AV cannot collect sufficient data to train the classification model. The method may determine the category of the augmentation object based on an accuracy of the reference classification model in classifying objects in the category. The reference classification model may be a real-world model trained based on data collected from a real-world scene or a simulated model trained based on data generated from a simulated scene simulating a real-world scene. In some embodiments, the category of the augmentation object may be determined by comparing the accuracy of the real-world model in classifying objects in the category with the corresponding accuracy of the simulated model. Multiple augmentation objects in the category may be generated. The augmentation objects may have different attributes, such as different colors, different orientations, different sizes, different patterns, different shapes, or some combination thereof.

The augmented scene can be used to train a classification model (“augmented model”) to be used by AVs to classify objects. The augmentation object may be labeled in the augmented scene. Also, a simulated AV, which is a virtual representation of a real-world AV, may be included in the augmented scene. The augmentation object can be placed in the vicinity of the simulated AV. The simulated AV generates simulated sensor data of the augmentation object, e.g., through a virtual onboard sensor suite of the simulated AV. The simulated sensor data and label of the augmentation object can be used as training data to train the augmented model. The training data may also include simulated sensor data and label of some or all of the virtual objects in the simulated scene. In some embodiments, the augmented model may be generated by modifying the simulated model by using the training data generated from the augmentation object.

By using the augmentation object, the augmented model can be trained based on training data that the simulated scene or real-world scene cannot provide or would be difficult to provide. Also, the training data generated from the augmentation object can target a category that the simulated model or real-world model has a poor performance. Accordingly, the augmented model can have better accuracy than the real-world model or the simulated model, particularly for the category of the augmentation object, and overcome the drawbacks of the real-world model or the simulated model. Additionally, as the augmented scene is a virtual scene, it may be modified to adapt to different real-world scenes and therefore can reduce the time and costs needed for collecting training data from those real-world scenes. Also, many augmentation objects of various attributes can be added into the augmented scene. However, it can be expensive and challenging to produce many real-world objects of various attributes, not even to mention adding these augmentation objects into a real-world scene. Accordingly, compared with the real-world model, the augmented model can be more accurate in classifying objects of different attributes. Therefore, the method of using augmented scenes to train AV classification models is more advantageous.

Embodiments of the present disclosure provide a method for training a model. The method may include retrieving a simulated scene that simulates a first real-world scene; generating an augmentation object based on a performance of a real-world model, the real-world model trained based on real-world data collected from a second real-world scene and used for classifying objects; generating an augmented scene by placing the augmentation object into the simulated scene; generating a label of the augmentation object, the label describing a category of the augmentation object; and training a model by using the augmented scene and the label of the augmentation object, the model to be used by a vehicle to classify objects surrounding the vehicle during an operation of the vehicle.

Further embodiments of the present disclosure provide one or more non-transitory computer-readable storage media storing instructions executable to perform operations for training a model. The operations include retrieving a simulated scene that simulates a first real-world scene; generating an augmentation object based on a performance of a real-world model, the real-world model trained based on real-world data collected from a second real-world scene and used for classifying objects; generating an augmented scene by placing the augmentation object into the simulated scene; generating a label of the augmentation object, the label describing a category of the augmentation object; and training a model by using the augmented scene and the label of the augmentation object, the model to be used by a vehicle to classify objects surrounding the vehicle during an operation of the vehicle.

As will be appreciated by one skilled in the art, aspects of the present disclosure, in particular aspects of dispatch-based charging for electric vehicle fleets, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference may be made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings.

Other features and advantages of the disclosure will be apparent from the following description and the claims.

As described herein, one aspect of the present technology may be the gathering and use of data available from various sources to improve quality and experience. The present disclosure contemplates that in some instances, this gathered data may include personal information. The present disclosure contemplates that the entities involved with such personal information respect and value privacy policies and practices.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that may include X and Y.

In addition, the terms “comprise,” “comprising,” “include,” “including,” “have,” “having” or any other variation thereof, are intended to cover a non-exclusive inclusion. For example, a method, process, device, or system that comprises a list of elements may be not necessarily limited to only those elements but may include other elements not expressly listed or inherent to such method, process, device, or system. Also, the term “or” refers to an inclusive or and not to an exclusive or.

The systems, methods and devices of this disclosure each have several innovative aspects, no single one of which may be solely responsible for all of the desirable attributes disclosed herein. Details of one or more implementations of the subject matter described in this Specification are set forth in the description below and the accompanying drawings.

Example AV Environment

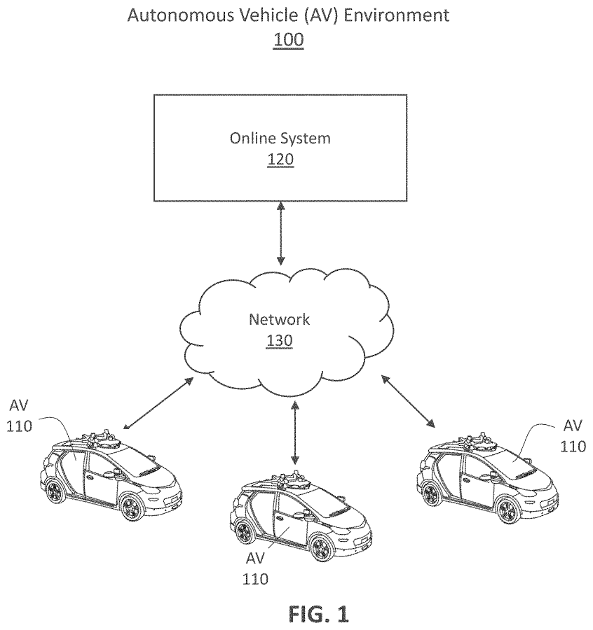

FIG. 1 shows an AV environment 100 according to some embodiments of the present disclosure. The AV environment 100 includes AVs 110 and an online system 120 in communication with the AVs 110 through a network 130. In other embodiments, the AV environment 100 may include fewer, more, or different components. For instance, the AV environment 100 may include a different number of AVs. A single AV may be referred to herein as AV 110, and multiple AVs are referred to collectively as AVs 110,

An AV 110 may be a vehicle that may be capable of sensing and navigating its environment with little or no user input. The AV 110 may be a semi-autonomous or fully autonomous vehicle, e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle. The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions; e.g., windshield wipers, headlights, turn indicators, air conditioning, etc.

An AV 110 may include an onboard sensor suite that detects objects in the surrounding environment of the AV 110 and generates sensor data describing the objects. Examples of the objects include people, buildings, trees, traffic signs, other vehicles, landmarks, street markers, and so on. The onboard sensor suite may generate sensor data of the objects. The sensor data of the objects may include images, depth information, location information, or other types of sensor data. The onboard sensor suite may include various types of sensors. In some embodiments, the onboard sensor suite may include a computer vision (“CV”) system, localization sensors, and driving sensors. For example, the onboard sensor suite may include photodetectors, cameras, RADAR, Sound Navigation And Ranging (SONAR), LIDAR, GPS, wheel speed sensors, inertial measurement units (IMUS), accelerometers, microphones, strain gauges, pressure monitors, barometers, thermometers, altimeters, ambient light sensors, etc. The sensors may be located in various positions in and around the AV 110.

The AV 110 may also include an onboard controller. The onboard controller controls operations and functionality of the AV 110. In some embodiments, the onboard controller may be a general-purpose computer, but may additionally or alternatively be any suitable computing device. The onboard controller may be adapted for I/O communication with other components of the AV 110 (e.g., the onboard sensor suite, etc.) and external systems (e.g., the online system 120). The onboard controller may be connected to the Internet via a wireless connection (e.g., via a cellular data connection). Additionally or alternatively, the onboard controller may be coupled to any number of wireless or wired communication systems.

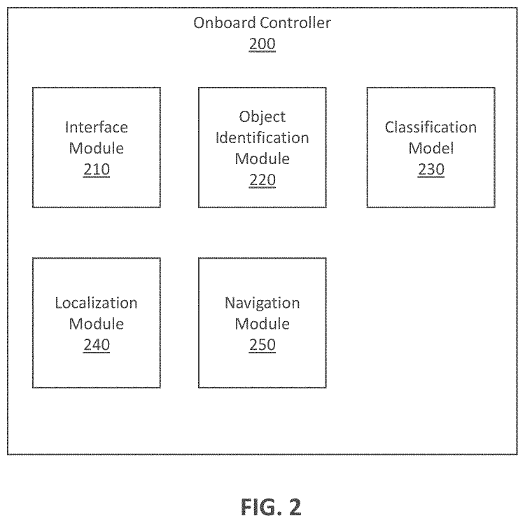

The onboard controller may process sensor data generated by the onboard sensor suite and/or other data (e.g., data received from the online system 120) to determine the state of the AV 110. In some embodiments, the onboard controller implements an autonomous driving system (ADS) for controlling the AV 110 and processing sensor data from the onboard sensor suite and/or other sensors in order to determine the state of the AV 110. For instance, the onboard controller may input the sensor data into a classification model to identify objects detected by the onboard sensor suite. The classification model may be an augmented model trained by using an augmented scene. The onboard controller may receive the classification model from a different system, e.g., the online system 120. Based upon the output of the classification model, vehicle state, or programmed instructions, the onboard controller can modify or control the behavior of the AV 110. For instance, the onboard controller can use the output of the classification model to localize or navigate the AV 110. More information of the onboard controller is described below in conjunction with FIG. 2.

An AV 110 may also include a rechargeable battery that powers the AV 110. The battery may be a lithium-ion battery, a lithium polymer battery, a lead-acid battery, a nickel-metal hydride battery, a sodium nickel chloride (“zebra”) battery, a lithium-titanate battery, or another type of rechargeable battery. In some embodiments, the AV 110 may be a hybrid electric vehicle that may also include an internal combustion engine for powering the AV 110, e.g., when the battery has low charge. In some embodiments, the AV 110 may include multiple batteries, e.g., a first battery used to power vehicle propulsion, and a second battery used to power AV hardware (e.g., the onboard sensor suite and the onboard controller 117). The AV 110 may further include components for charging the battery, e.g., a charge port configured to make an electrical connection between the battery and a charging station.

The online system 120 can support the operation of the AVs 110. In some embodiments, the online system 120 may train an augmented model that the AVs 110 can use to detect objects. In some embodiments, the online system 120 may generate a simulated scene simulating a real-world scene and place one or more augmentation objects into the simulated scene to augment the simulated scene. The augmentation objects can represent objects in a category for which a real-world model or a simulated model fails to accurately classify. The category may be underrepresented in the real-world scene used to train the real-world model or simulated model. The online system 120 may generate a training set that includes simulated sensor data of the augmentation object and a label created for the augmentation object. The training set may also include simulated sensor data and labels of simulated objects representing real-world objects in the real-world scene. The simulated sensor data of an object (augmentation object or simulated object) may be generated by one or more simulated sensors on a virtual AV that simulates an AV 110 in the augmented scene. The online system 120 can provide the augmented model to the AVs 110 through the network 130. The online system 120 may continuously train the augmented model and update the augmented model in the AV 110 as the augmented model is further trained and modified.

In some embodiments, the online system 120 may manage a service that provides or uses the AVs 110, e.g., a service for providing rides to users with the AVs 110, or a service that delivers items using the AVs (e.g., prepared foods, groceries, packages, etc.). The online system 120 may select an AV from a fleet of AVs 110 to perform a particular service or other task. The online system 120 may instruct the selected AV 110 to autonomously drive to a particular location (e.g., a delivery address). The online system 120 may also manage fleet maintenance tasks, such as charging and servicing of the AVs 110.

In some embodiments, the online system 120 may also provide the AV 110 (and particularly, onboard controller) with system backend functions. The online system 120 may include one or more switches, servers, databases, live advisors, or an automated voice response system (VRS). The online system 120 may include any or all of the aforementioned components, which may be coupled to one another via a wired or wireless local area network (LAN). The online system 120 may receive and transmit data via one or more appropriate devices and network from and to the AV 110, such as by wireless systems, such as a wireless local area network (WLAN) (e.g., an IEEE 802.11 based system), a cellular system (e.g., a wireless system that utilizes one or more features offered by the 3rd Generation Partnership Project (3GPP), including GPRS), and the like. A database at the online system 120 can store account information, such as subscriber authentication information, vehicle identifiers, profile records, behavioral patterns, and other pertinent subscriber information. The online system 120 may also include a database of roads, routes, locations, etc. permitted for use by the AVs 110. The online system 120 may communicate with the AV 110 to provide route guidance in response to a request received from the vehicle.

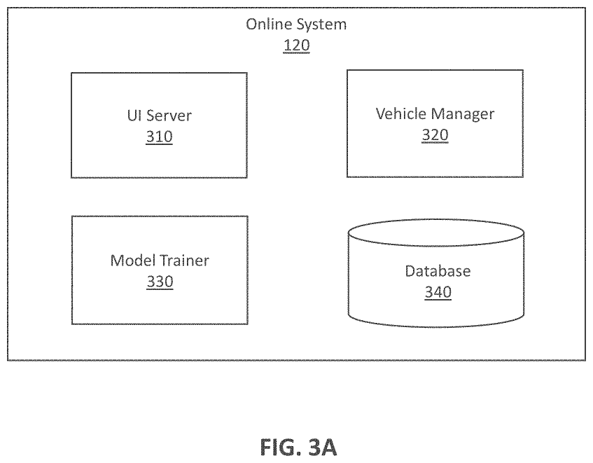

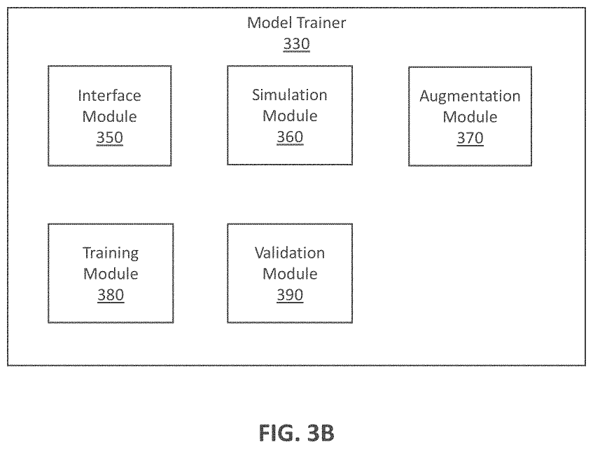

For example, based upon information stored in a mapping system of the online system 120, the online system 120 may determine the conditions of various roads or portions thereof. The AV 110, may, in the course of determining a navigation route, receive instructions from the online system 120 regarding which roads or portions thereof, if any, are appropriate for use under certain circumstances, as described herein. Such instructions may be based in part on information received from the AV 110 or other autonomous vehicles regarding road conditions. Accordingly, the online system 120 may receive information regarding the roads/routes generally in real-time from one or more vehicles. More details of the online system 120 are provided below in conjunction with FIG. 3A and FIG. 3B.

The network 130 can support communications between an AV 110 and the online system 120. The network 130 may comprise any combination of local area and/or wide area networks, using both wired and/or wireless communication systems. In one embodiment, the network 130 may use standard communications technologies and/or protocols. For example, the network 130 may include communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 130 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 130 may be represented using any suitable format, such as hypertext markup language (HTML) or extensible markup language (XML). In some embodiments, all or some of the communication links of the network 130 may be encrypted using any suitable technique or techniques.

Example Onboard Controller

FIG. 2 is a block diagram illustrating an onboard controller 200 of an AV 110 according to some embodiments of the present disclosure. The onboard controller 200 may include an interface module 210, an object identification module 220, a classification model 230, a localization module 240, and a navigation module 250. Alternative configurations, different or additional components may be included in the onboard controller 200. Further, functionality attributed to one component of the onboard controller 200 may be accomplished by a different component included in the onboard controller 200, the AV 110, or a different system, e.g., the online system 120.

The interface module 210 can facilitate communications of the onboard controller 200 with other systems. For instance, the interface module 210 may support communications of the onboard controller 200 with the online system 120. The interface module 210 may also facilitate communications of the onboard controller 200 with other components of the AV 110, e.g., the onboard sensor suite. For instance, the interface module 210 may receive classification models from the online system 120, retrieve sensor data generated by the onboard sensor suite, and so on.

The object identification module 220 can use the classification model 230 to determine categories of objects. The classification model 230 may be a real-world model trained by using data collected from a real-world scene, a simulated model trained by using data collected from a simulated scene, or an augmented model trained by using data collected from an augmented scene. The object identification module 220 may input sensor data of the objects into the classification model 230. The classification model 230, receiving the sensor data, can output the categories of the objects. The sensor data of the objects may include sensor data generated by the onboard sensor suite of the AV 110, such as images, depth information, location information, etc. The sensor data of the objects may include data received from the online system 120 or a sensor external to the AV 110.

The localization module 240 can localize the AV 110. In some embodiments, the localization module 240 determines where the AV is located, e.g., whether the AV 110 has arrived at a predetermined location (e.g., a destination of a delivery service). For instance, the localization module 240 may determine the location of the AV 110. The localization module 240 may further compare the location of the AV 110 with the predetermined location to determine whether the AV 110 has arrived. The localization module 240 can further localize the AV 110 with respect to a site or an object. For instance, the localization module 240 can determine a pose (e.g., position and/or orientation) of the AV 110 in the site. The localization module 240 can also determine a pose of the AV 110 with respect to an object in the site.

The localization module 240 may use sensor data generated by the onboard sensor suite to determine where the AV 110 is located. The sensor data may include information describing an absolute or relative position of the AV 110 (e.g., data generated by GPS, GNSS (Global Navigation Satellite System), IMU, etc.), information describing features surrounding the AV 110 (e.g., data generated by a camera, RADRA, SONAR, LIDAR, etc.), information describing motion of the AV 110 (e.g., data generated by the motion sensor), or some combination thereof. Additionally or alternatively, the localization module 240 may use objects identified by the object identification module 220 to localize the AV 110. For instance, the localization module 240 uses the identification of an object to determine whether the AV 110 has arrived at a location associated with the object.

The navigation module 250 can control the motion of the AV 110. The navigation module 250 may control the motor of the AV 110 to start, pause, resume, or stop motion of the AV 110. The navigation module 250 may further control the wheels of the AV 110 to control the direction the AV 110 will move. In various embodiments, the navigation module 250 generates a navigation route for the AV 110 based on a location of the AV 110, a destination, and a map. The navigation module 250 may receive the location of the AV 110 from the localization module 240. The navigation module 250 may receive a request to go to a location and generate a route to navigate the AV 110 from its current location, which may be determined by the localization module 240, to the location. The navigation module 250 may receive the destination through the interface module 210.

In some embodiments, the navigation module 250 can control the motion of the AV 110 based on object identification performed by the object identification module 220. The navigation module 250 may determine whether to stop or start of the motion of the AV 110 based on the identification of one or more objects in the vicinity of the AV 110, In an example where the object identification module 220 identifies a stop sign in the vicinity of the AV 110, the navigation module 250 can stop the motion of the AV 110. The navigation module 250 may determine or modify a navigation route for the AV 110 based on the identification of one or more objects in the vicinity of the AV 110. For instance, after the object identification module 220 identifies a tree in the vicinity of the AV 110, the navigation module 250 may control the AV 110 to navigate around the tree. The navigation module 250 may also determine or modify a motion speed of the AV 110 based on the identification of objects in the vicinity of the AV 110, The navigation module 250 may further change a pose of the AV 110 based on the identification of objects in the vicinity of the AV 110.

Example Online System

FIG. 3A is a block diagram illustrating the online system 120 according to some embodiments of the present disclosure. The online system 120 may include a UI server 310, a vehicle manager 320, a model trainer 330, and a database 340. In alternative configurations, different or additional components may be included in the online system 120. Further, functionality attributed to one component of the online system 120 may be accomplished by a different component included in the online system 120 or a different system, e.g., the onboard controller 200.

The UI server 310 may be configured to communicate with third-party devices that provide a UI to users. For example, the UI server 310 may be a web server that provides a browser-based application to third-party devices, or the UI server 310 may be a mobile app server that interfaces with a mobile app installed on third-party devices. The UI enables the user to access a service of the online system 120, e.g., to request a delivery by using an AV 110.

The vehicle manager 320 manages and communicates with a fleet of AVs, e.g., the AVs 110 in FIG. 1. The vehicle manager 320 may assign AVs 110 to various tasks and direct the movements of the AVs 110 in the fleet. For example, the vehicle manager 320 assigns an AV 110 to perform a delivery service requested by a user through the UI server 310. The vehicle manager 320 may instruct AVs 110 to drive to other locations while not servicing a user, e.g., to improve geographic distribution of the fleet, to anticipate demand at particular locations, to drive to a charging station for charging, etc. The vehicle manager 320 also instructs AVs 110 to return to AV facilities for recharging, maintenance, or storage.

The model trainer 330 can train an augmented model to be used by AVs 110 to identify objects. The model trainer 330 may generate an augmented scene by placing one or more augmentation objects into a simulated scene. The simulated scene includes simulated objects generated based on real-world objects in a real-world scene. Simulated objects can be virtual objects simulating real-world objects that exist in the real-world scene. In an embodiment, each simulated object may be a virtual object and represents one of the real-world objects. An augmentation object may be a virtual object representing a category of objects for which a real-world model or simulated model cannot accurately identify (e.g., the model cannot identify/classify within a threshold level of success/accuracy and/or confidence). Augmentation objects can be virtual objects that do not simulate any of the real-world objects as the real-world scene do not have such objects. For instance, the real-world scene does not include any objects in the category of an augmentation object or does not include any objects having the attributes (e.g., size, color, pattern, pose (position or orientation) in the scene, etc.) of an augmentation object. Accordingly, by placing the augmentation object into the simulated scene, the simulated scene is augmented to generate an augmented scene. The model trainer 330 can generate multiple augmentation objects for one category. The augmentation objects of the same category may be the same or have different attributes. For instance, the augmentation objects of the same category may have different sizes, colors, patterns, orientations, shapes, and so on. The model trainer 330 may label each augmentation object based on the category of the augmentation object. Such augmentation objects can provide training data to train classification models capable of accurately classifying objects having different attributes.

The model trainer 330 may also simulate navigation of an AV 110 in the augmented scene, e.g., by generating a virtual AV that simulates the AV 110 and navigating the virtual AV in the augmented scene. The virtual AV may navigate along a route in the vicinity of the augmentation objects and provide simulated sensor data generated by the onboard sensor suite of the virtual AV. The simulated sensor data may include data of the augmentation objects. The model trainer 330 can form a training set by including the data of the augmentation objects (e.g., simulated sensor data) and the labels of the augmentation objects. The model trainer 330 can further train the augmented model by using the training set, The training set may also include data of simulated objects in the augmented scene and labels of the simulated objects. In some embodiments, the model trainer may train the augmented model by modifying a real-world model or simulated model, e.g., by using the augmented scene to further train the real-world model or simulated model.

The database 340 can store data used, generated, received, or otherwise associated with the online system 120. The database 340 may store augmented models generated by the model trainer 330. The database 340 may also store data associated with the AVs 110, data received from third-party systems, and so on.

FIG, 3B is a block diagram illustrating the model trainer 330 of the online system 120 according to some embodiments of the present disclosure. The model trainer 330 in FIG. 3B includes an interface module 350, a simulation module 360, an augmentation module 370, a training module 380, and a validation module 390,

The interface module 350 can facilitate communications of the model trainer 330 with other systems. For instance, the interface module 350 may support communications of the model trainer 330 with the other components of the online system 120. The interface module 350 may also facilitate communications of the model trainer 330 with other components of the AV 110, e.g., the onboard sensor suite. For instance, the interface module 350 may receive a simulated scene from the database 340. As another example, the interface module 350 may receive sensor data generated by the onboard sensor suite, and so on.

The simulation module 360 can generate simulated scenes. The simulation module 360 may generate a simulated scene based on a real-world scene, e.g., a city or a district in a city that was captured by sensors of AVs 110 operating in the real world. In some embodiments, the simulation module 360 may identify real-world objects in the real-world scene. The real-world objects may include people, buildings, street marks (e.g., curbs, lane markers, etc.), traffic signs, trees, landmarks, or other types of objects that can be present in the real-world scene. The simulation module 360 may generate a simulated object for each identified real-world object (or each of a subset of the identified real-world objects). The simulated object may be a virtual object representing the corresponding real-world object, e.g., a two-dimensional or three-dimensional graphic representation of the corresponding real-world object. The simulation module 360 may further combine the simulated objects to generate the simulated scene. Accordingly, the simulated scene can be a virtual representation of the real-world scene. In other embodiments, the simulation module 360 may generate the simulated scene by modifying a second simulated scene. The second simulated scene may mirror a second real-world scene. The simulation module 360 can analyze the differences between the second real-world scene and the first real-world scene and incorporate the differences into the second simulated scene to generate the simulated scene. In an example, the simulation module 360 can retrieve a simulated scene of a first district in San Francisco and use the simulated scene of the first district to generate a simulated scene of a second district in San Francisco by modifying the simulated scene of the first district based on differences between the two districts.

The simulation module 360 may label the simulated objects. For instance, the augmentation module 370 may generate a label for each simulated object based on the known category of the simulated object. The label may describe the category of the simulated object. The simulation module 360 may also generate a simulated AV, which is a virtual AV that simulates an AV 110. The simulation module 360 may place the virtual AV in the simulated scene. The simulated AV can navigate in the simulated scene. The simulated AV may include a simulated onboard sensor suite that simulates the onboard sensor suite of the AV 110. The virtual onboard sensor suite can detect objects in the surrounding environment of the simulated AV. For instance, the simulated onboard sensor suites may generate simulated sensor data of the simulated objects, e.g., images, audio, depth information, location information, and so on.

The augmentation module 370 can generate an augmented scene from the simulated scene. The augmentation module 370 augments the simulated scene with one or more augmentation objects. An augmentation object may be a virtual object that can be placed into the simulated scene to augment the simulated scene. The augmentation object may represent a category that is underrepresented in a real-world scene used to train a references classification model. For instance, the real-world scene may include no objects in the category or a small number of objects in the category. As another example, even though the real-world scene includes objects in the category, an AV navigating in the real-world scene cannot detect enough of these objects, e.g., due to the locations of these objects in the real-world scene. Alternatively, the augmentation object may correspond to objects that the model is unable to correctly classify/identify or classifies correctly below a threshold level of confidence.

The reference classification model may be a real-world model or simulated model. The real-world model is a classification model trained by using sensor data of real-world objects, e.g., sensor data generated by an onboard sensor suite of an AV 110 navigating in a real-world scene where the real-world objects are located. The real-world scene used for training the real-world model and the real-world scene used for generating the simulated scene may be the same scene. For example, the real-world model may be trained by data collected from locations throughout San Francisco and the simulated scene is generated to simulate these locations in San Francisco. As another example, the real-world model may be trained by data collected from locations in San Francisco, but the simulated scene is generated to simulate locations in Phoenix. The simulated model is a classification model trained by using simulated sensor data of simulated objects collected from a simulated scene representing a real-world scene. The simulated scene used for training the simulated model and the simulated scene generated by the simulation module 360 may be the same.

In some embodiments, the augmentation module 370 may generate an augmentation object based on a performance of one or more reference classification models in classifying objects in the category of the augmentation object. In an embodiment, the augmentation module 370 may evaluate the performance of the reference classification model and identifies the category based on the evaluation. For instance, the augmentation module 370 may measure an accuracy of the reference classification model in classifying objects in the category. The augmentation module 370 may determine an accuracy score measuring the precision, recall, or a combination of precision and recall of the reference classification model. The augmentation module 370 may use the following metrics to determine the accuracy score: Precision=TP (TP+FP) and Recall=TP (TP+FN), where precision (P) may be how many objects the reference classification model correctly predicted (TP or true positives) out of the total it predicted (TP+FP or false positives), and recall (R) may be how many objects the reference classification model correctly predicted (TP) out of the total number of objects that did have the property in question (TP+FN or false negatives). The F-score (F-score=2* P*R/(P+R)) unifies precision and recall into a single measure.

In an example where the accuracy score is lower than a threshold score, the augmentation module 370 determines that the reference classification model cannot accurately classify objects in the category and based on the category, generates the augmentation object. In some embodiments, the augmentation module 370 may compare the accuracy score of two reference classification models. For instance, the augmentation module 370 may compare the accuracy score of a real-world model with the corresponding accuracy score of a simulated model. In an example where the accuracy score of the simulated model is lower than the accuracy score of the real-world model, the augmentation module 370 generates the augmentation object based on the category.

The augmentation module 370 may generate a group of augmentation objects in the category. The augmentation objects in the group may have different attributes. The different attributes may include different colors, different orientations, different sizes, different patterns, different shapes, or some combination thereof. The augmentation module 370 may identify multiple categories and generate one or more augmentation objects for each of the identified categories.

The augmentation module 370 can place the augmentation objects into the simulated scene and generate the augmented scene. The simulated AV may navigate in the augmented scene to collect sensor data of the augmentation objects or the simulated objects in the augmented scene, e.g., through the simulated onboard sensor suite. In some embodiments, the augmentation module 370 may determine a navigation route of the simulated AV in the augmented scene and place the augmentation objects based on the navigation route. For instance, the augmentation module 370 may place the augmentation objects along the navigation route so that the augmentation objects can be detected by the simulated onboard sensor suite. The augmentation module 370 may further label the augmentation objects. For instance, the augmentation module 370 may generate a label for each augmentation object based on the known category of the augmentation object. The label may describe the category of the augmentation object (e.g., cone or trees).

The training module 380 can train an augmented model by using the augmented scene. The training module 380 applies machine learning techniques to generate the augmented model that when applied to sensor data of objects, outputs categories/labels of the objects. In some cases, confidence score can also be generated by the augmented model along with the categories/labels. As part of the generation of the augmented model, the training module 380 forms a training set. The training set may include the sensor data of the augmentation objects and the labels of the augmentation objects. The training set may also include the sensor data of one or more simulated objects and the labels of the simulated objects.

The training module 380 may extract feature values from the training set, the features being variables deemed potentially relevant to classification of the augmentation objects or simulated objects. The feature values extracted by the training module 380 may include, e.g., shape, size, color, pattern, material, or other types of attributes of the objects. An ordered list of the features for an object may be herein referred to as the feature vector for the object. In one embodiment, the training module 380 may apply dimensionality reduction (e.g., via linear discriminant analysis (LDA), principle component analysis (PCA), or the like) to reduce the amount of data in the feature vectors to a smaller, more representative set of training data.

The training module 380 may use supervised machine learning to train the classification model, with the feature vectors of the training set serving as the inputs. Different machine learning techniques—such as linear support vector machine (linear SVM), boosting for other algorithms (e.g., AdaBoost), neural networks (e.g., convolutional neural network), logistic regression, naive Bayes, memory-based learning, random forests, bagged trees, decision trees, boosted trees, or boosted stumps—may be used in different embodiments. The augmented model, when applied to the feature vector extracted from an object, outputs a category of the object, such as a Boolean yes/no estimate, or a scalar value representing a probability.

In some embodiments, the training module 380 may generate the augmented model by modifying a simulated model or real-world model. For instance, the training module 380 may re-train the simulated model or real-world model by using the augmented scene. In some embodiments, the training module 380 may continuously train the augmented model. For instance, the augmentation module 370 may identify a new category that the reference classification model cannot accurately classify and updates the augmented scene with augmentation objects in the new category. The augmentation module 370 may communication with the training module 380 regarding the updated augmented scene. The training module 380 can generate new training data from the updated augmented scene and re-train the augmented model by using the new training data.

The validation module 390 can validates a performance of the augmented model in classifying objects. The validation module 390 may particularly validate the performance of the augmented model in classifying objects in the category of the augmentation objects. In some embodiments, a validation set may be formed of additional objects, other than those in the training sets, whose category has been known. The validation module 390 applies the augmented model to the objects in the validation set to quantify the accuracy of the augmented model. For instance, the validation module 390 determines an accuracy score of the augmented model by using the accuracy measurement metric described above. The validation module 390 may compare the accuracy score with a threshold score or an accuracy score of a reference model (e.g., the real-world model). In an example where the validation module 390 determines that the accuracy score of the augmented model is lower than the threshold score or the accuracy score of the reference model, the validation module 390 instructs the training module 380 to re-train the augmentation model. In one embodiment, the training module 380 may iteratively re-train the augmented model until the occurrence of a stopping condition, such as the accuracy measurement indication that the augmented model may be sufficiently accurate, or a number of training rounds having taken place.

Example Augmented Scene

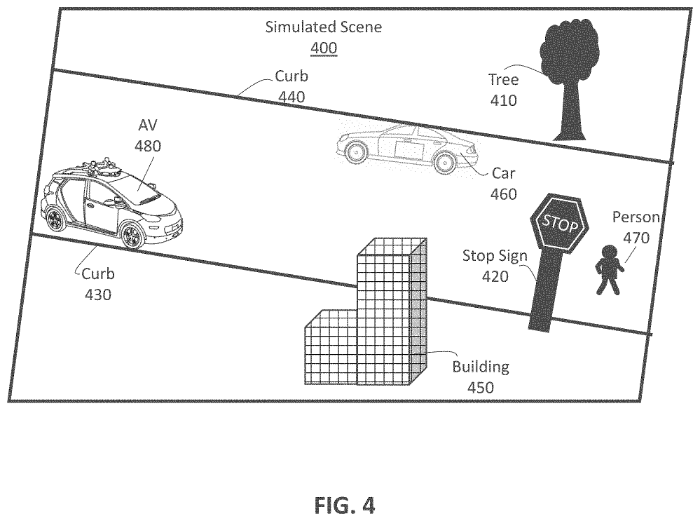

FIG. 4 illustrates a simulated scene 400 according to some embodiments of the present disclosure. The simulated scene 400 may be generated by the simulation module 360 in FIG. 3B. The simulated scene 400 is a virtual representation of a real-world scene. In FIG. 4, the simulated scene 400 includes a plurality of virtual objects: a virtual tree 410, a virtual stop sign 420, a virtual curb 430, another virtual curb 440, a virtual building 450, a virtual car 460, and a virtual person 470. Additionally, the simulated scene 400 includes a simulated AV 480, which may be a virtual representation of a real-world AV, e.g., the AV 110. The simulated AV 480 may have a simulated onboard sensor suite that detects objects in the surrounding environment of the simulated AV 480. The simulated onboard sensor suite may be a virtual representation of the onboard sensor suite of an AV 110 described above. The simulated AV 480 may also have a simulated onboard controller that is a virtual representation of the onboard controller 200. The simulated AV 480 may also navigate in the simulates scene 400.

In other embodiments, the simulated scene 400 may include different, more, or fewer virtual objects. Each of the virtual objects may be a virtual representation of a real-world object in the real-world scene. In some embodiments, the real-world scene may include real-world objects that are not represented by any of the virtual objects in the simulated scene. The simulated scene 400 can be used to train a simulated model.

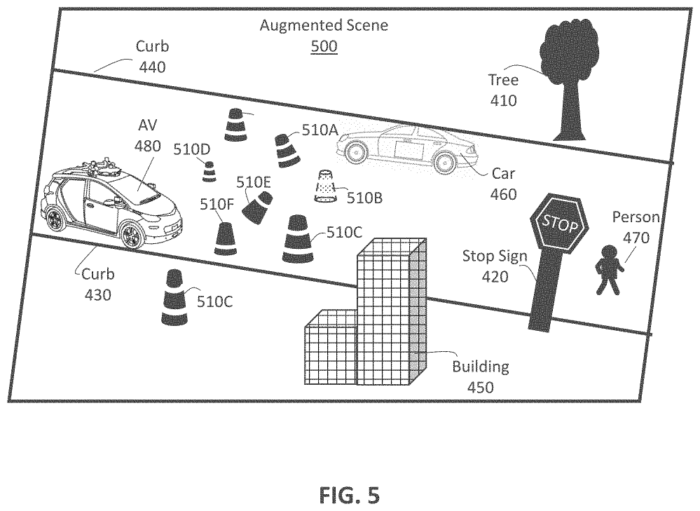

FIG. 5 illustrates an augmented scene 500 generated based on the simulated scene 400 in FIG. 4 according to some embodiments of the present disclosure. The augmented scene 500 includes all the virtual objects in the simulated scene 400 and augmented objects 510A-F. The augmented objects 510A-F can represent construction cones which are not present in the real-world scene. In some embodiments, the real-world scene may include one or more construction cones, but does not include construction cones represented by the augmented objects 510A-F. For example, the real-world scene does not have construction cones with the attributes of the augmentation objects 510. In another example, the real-world scene does not have enough construction cones for training an accurate classification model. The addition of the augmentation objects 510A-F can therefore provide more data to train a more accurate classification model. The augmentation objects 510A-F are added to the simulated scene 400 to augment the simulated scene 400 and to provide training data to train an augmented model. In some embodiments, it can be determined that compared with a real-world model, a simulated model is less accurate in identifying construction cones or that the real-world model itself is not accurate in identifying construction cones. Based on such a determination, the augmentation objects can be generated, labeled, and placed into the simulated scene 400. In FIG. 5, the augmentation objects 510A-F are placed in the vicinity of the simulated AV 480 so that the virtual onboard sensor suite of the simulated AV 480 can detect the augmentation objects 510A-F and generate sensor data of the augmentation objects 510A-F. The sensor data and labels of the augmentation objects 510A-F can be used as training data to train an augmented model. The augmented model can have better accuracy in identifying construction cones than the simulated model or real-world model.

In FIG. 5, the augmentation objects 510A-F have different attributes. For instance, the augmentation object 510B has a different color from the other augmentation objects 510A and 510C-F. Also, the augmentation object 510C is larger than the augmentation object 510D. Further, the augmentation objects 510E-F have different patterns from the augmentation objects 510A-D. For purpose of simplicity and illustration, FIG. 5 shows eight augmentation objects of a same category. In other embodiments, the augmented scene 500 may include different, fewer, or more augmentation objects and may include augmentation objects of different categories. Also, construction cones are used as an example category in FIG. 5, augmentation objects can be of other categories. In an embodiment, an augmentation object may be a combination of a group of virtual objects, e.g., a virtual object in the group is at least partially occluded by one or more other virtual objects in the group.

Example Processes for Training Augmented Model

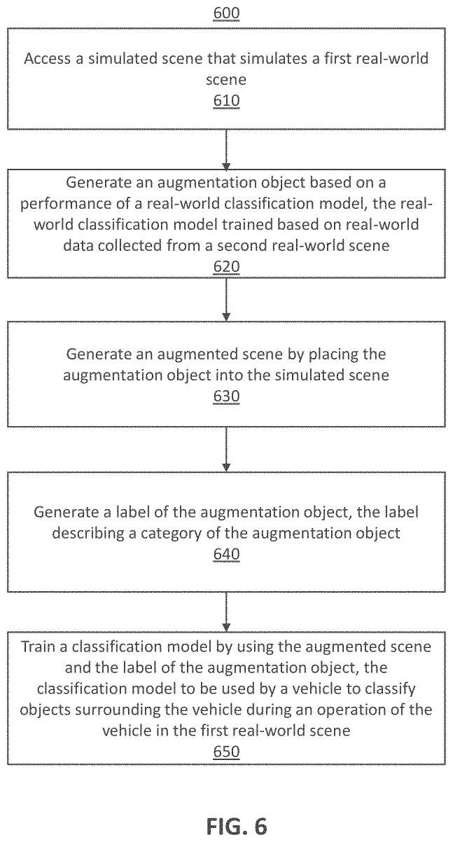

FIG. 6 is a flowchart showing a method 600 of training an augmented model according to some embodiments of the present disclosure. The method may be performed by the online system 120, such as the model trainer 330 of the online system 120.

The online system 120 accesses 610 a simulated scene that simulates a first real-world scene. The online system 120 may generate the simulated scene by using data collected from the first real-world scene. The online system 120 generates 620 an augmentation object based on a performance of a real-world classification model. The real-world classification model is trained based on real-world data collected from a second real-world scene. The first real-world scene and second real-world scene may be the same real-world scene.

In some embodiments, the online system 120 may evaluate the performance of the real-world classification model by determining a first accuracy score that indicates an accuracy of the real-world classification model in classifying objects in the category. The online system 120 may generate the augmentation object based on the first accuracy score. The first accuracy score can measure a precision or recall of the real-world classification model. The online system 120 may determine whether the first accuracy score may be below a threshold score. In response to determining that the first accuracy score may be below a threshold score, the online system 120 may generate the augmentation object in the category.

The online system 120 may also determine a second accuracy score that indicates an accuracy of a simulated classification model in classifying objects in the category. The simulated model can be a classification model trained by using a second simulated scene that simulates the second real-world scene. The online system 120 may determine whether the second accuracy score may be lower than the first accuracy score. In response to determining that the second accuracy score may be lower than the first accuracy score, the online system 120 may generate the augmentation object in the category. The online system 120 may generate an additional augmentation object in the category. The additional augmentation object can have a different attribute (e.g., a different color, a different orientation, a different size, a different pattern, a different shape, or some combination thereof) from the augmentation object.

The online system 120 generates 630 an augmented scene by placing the augmentation object into the simulated scene. The online system 120 may place the augmentation object in a vicinity of a simulated vehicle in the simulated scene. The online system 120 generates 640 a label of the augmentation object. The label describes the category of the augmentation object.

The online system 120 trains 650 the classification model by using the augmented scene and the label of the augmentation object. The classification model can be used by a vehicle (e.g., an AV 110) to classify objects surrounding the vehicle during an operation of the vehicle in the first real-world scene. The classification model may be trained to receive data collected by the vehicle from the first real-world scene and to output classifications of objects in the first real-world scene.

The online system 120 can also validate an accuracy of the classification model in classifying objects in the category of the augmentation object. For instance, the online system 120 may determine a precision or recall of the classification model in classifying objects in the category. The online system 120 may validate whether an accuracy of the real-world classification model in classifying objects in the category of the augmentation object may be better than the accuracy of the classification model in classifying objects in the category of the augmentation object.

### SELECT EXAMPLES

Example 1 provides a method for autonomously charging a vehicle, the method including accessing a simulated scene that simulates a first real-world scene; generating an augmentation object based on a performance of a real-world classification model, the real-world classification model trained by using data collected from a second real-world scene; generating an augmented scene by placing the augmentation object into the simulated scene; generating a label of the augmentation object, the label describing a category of the augmentation object; and training the classification model by using the augmented scene and the label of the augmentation object, the classification model to be used by a vehicle to classify objects surrounding the vehicle during an operation of the vehicle.

Example 2 provides the method according to example 1, where generating the augmentation object based on the performance of the real-world classification model includes evaluating the performance of the real-world classification model by determining a first accuracy score that indicates an accuracy of the real-world classification model in classifying objects in the category of the augmentation object; and generating the augmentation object based on the first accuracy score.

Example 3 provides the method according to example 1 or 2, where the first accuracy score measures a precision or recall of the real-world classification model.

Example 4 provides the method according to example 2 or 3, where generating the augmentation object based on the first accuracy score includes determining a second accuracy score that indicates an accuracy of a simulated classification model in classifying objects in the category, the simulated classification model trained by using a second simulated scene that simulates the second real-world scene; determining whether the second accuracy score is lower than the first accuracy score; and in response to determining that the second accuracy score is lower than the first accuracy score, generation the augmentation object in the category.

Example 5 provides the method according to any of examples 2-4, where generating the augmentation object based on the first accuracy score includes determining whether the first accuracy score is below a threshold score; and in response to determining that the first accuracy score is below a threshold score, generation the augmentation object in the category.

Example 6 provides the method according to any of the preceding examples, where generating an augmented scene by placing the augmentation object into the simulated scene includes placing the augmentation object in a vicinity of a simulated vehicle in the simulated scene.

Example 7 provides the method according to any of the preceding examples, where generating the augmentation object based on the performance of the real-world classification model includes generating an additional augmentation object in the category of the augmentation object, the additional augmentation object having a different attribute from the augmentation object.

Example 8 provides the method according to example 7, where the different attribute is a different color, a different orientation, a different size, a different pattern, a different shape, or some combination thereof.

Example 9 provides the method according to any of the preceding examples, where training the classification model by using the augmented scene and the label includes simulating a virtual vehicle that operates in the augmented scene and generates simulated sensor data of the augmentation object; forming a training set including the simulated sensor data and the label; training the classification model based on the training set.

Example 10 provides the method according to example 9, where the simulated sensor data is generated by one or more onboard virtual sensors of the virtual vehicle.

Example 11 provides the method according to example 9 or 10, where the simulated scene includes virtual objects simulating objects in the first real-world scene, and the training set further includes sensor data of the virtual objects and labels of the virtual objects.

Example 12 provides the method according to any of the preceding examples, where training the classification model by using the augmented scene and the label includes modifying a simulated classification model by using the augmentation scene and the label, wherein the simulated classification model has been trained by using the simulated scene.

Example 13 provides the method according to any of the preceding examples, where the method further includes validating an accuracy of the classification model in classifying objects in the category of the augmentation object.

Example 14 provides the method according to example 13, where validating the accuracy of the classification model in classifying objects in a category of the augmentation object includes determining a precision or recall of the classification model in classifying objects in the category of the augmentation object.

Example 15 provides the method according to example 13 or 14, where validating the accuracy of the classification model in classifying objects in the category of the augmentation object includes determining whether an accuracy of the real-world classification model in classifying objects in the category of the augmentation object is better than the accuracy of the classification model in classifying objects in the category of the augmentation object.

Example 16 provides the method according to any of examples 13-15, where validating the accuracy of the classification model in classifying objects in the category of the augmentation object includes generating validation objects in the category of the augmentation object; updating the augmented scene by placing the validation objects into the augmented scene; and validating the accuracy of the classification model by using the updated augmented scene.

Example 17 provides the method according to any of the preceding examples, where the first real-world scene and second real-world scene are a same real-world scene.

Example 18 provides the method according to any of the preceding examples, where the classification model is trained to receive sensor data generated by the vehicle and to output classifications of objects.

Example 19 provides one or more non-transitory computer-readable media storing instructions executable to perform operations for training a classification model, the operations including accessing a simulated scene that simulates a first real-world scene; generating an augmentation object based on a performance of a real-world classification model, the real-world classification model trained by using data collected from a second real-world scene; generating an augmented scene by placing the augmentation object into the simulated scene; generating a label of the augmentation object, the label describing a category of the augmentation object; and training the classification model by using the augmented scene and the label of the augmentation object, the classification model to be used by a vehicle to classify objects surrounding the vehicle during an operation of the vehicle.

Example 20 provides computer-implemented system for training a classification model. The computer-implemented system includes a processor; and one or more non-transitory computer-readable media storing instructions, when executed by the processor, cause the processor to perform operations, the operations including accessing a simulated scene that simulates a first real-world scene; generating an augmentation object based on a performance of a real-world classification model, the real-world classification model trained by using data collected from a second real-world scene; generating an augmented scene by placing the augmentation object into the simulated scene; generating a label of the augmentation object, the label describing a category of the augmentation object; and training the classification model by using the augmented scene and the label of the augmentation object, the classification model to be used by a vehicle to classify objects surrounding the vehicle during an operation of the vehicle.

### Other Implementation Notes, Variations, and Applications

It may be to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It may be also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it may be intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (1) of 35 U.S.C. Section 112 as it exists on the date of the filing hereof unless the words “means for” or “step for” are specifically used in the particular claims; and (b) does not intend, by any statement in the Specification, to limit this disclosure in any way that may be not otherwise reflected in the appended claims.

What is claimed is:

1. A method for training a classification model, the method comprising:
accessing a simulated scene that simulates a first real-world scene;
generating an augmentation object based on a performance of a real-world classification model, wherein the real-world classification model is trained using data collected from a second real-world scene;
generating an augmented scene by placing the augmentation object into the simulated scene;
generating a label of the augmentation object, the label describing a category of the augmentation object; and
training the classification model by using the augmented scene and the label of the augmentation object, wherein the classification model is to be used by a vehicle to classify objects surrounding the vehicle during an operation of the vehicle.

2. The method of claim 1, wherein generating the augmentation object based on the performance of the real-world classification model comprises:
evaluating the performance of the real-world classification model by determining a first accuracy score that indicates an accuracy of the real-world classification model in classifying objects in the category of the augmentation object; and
generating the augmentation object based on the first accuracy score.

3. The method of claim 2, wherein the first accuracy score measures a precision or recall of the real-world classification model.

4. The method of claim 2, wherein generating the augmentation object based on the first accuracy score comprises:
determining a second accuracy score that indicates an accuracy of a simulated classification model in classifying objects in the category, the simulated classification model trained by using a second simulated scene that simulates the second real-world scene;
determining whether the second accuracy score is lower than the first accuracy score; and
in response to determining that the second accuracy score is lower than the first accuracy score, generating the augmentation object in the category.

5. The method of claim 2, wherein generating the augmentation object based on the first accuracy score comprises:
determining whether the first accuracy score is below a threshold score; and
in response to determining that the first accuracy score is below a threshold score, generating the augmentation object in the category.

6. The method of claim 1, wherein generating an augmented scene by placing the augmentation object into the simulated scene comprises:
placing the augmentation object in vicinity of a simulated vehicle in the simulated scene.

7. The method of claim 1, wherein generating the augmentation object based on the performance of the real-world classification model comprises:
generating an additional augmentation object in the category of the augmentation object, the additional augmentation object having a different attribute from the augmentation object.

8. The method of claim 7, wherein the different attribute is a different color, a different orientation, a different size, a different pattern, a different shape, or some combination thereof.

9. The method of claim 1, wherein training the classification model by using the augmented scene and the label comprises:
simulating a virtual vehicle that operates in the augmented scene and generates simulated sensor data of the augmentation object;
forming a training set comprising the simulated sensor data and the label; and
training the classification model based on the training set.

10. The method of claim 9, wherein the simulated sensor data is generated by one or more onboard virtual sensors of the virtual vehicle.

11. The method of claim 9, wherein the simulated scene comprises virtual objects simulating objects in the first real-world scene, and the training set further comprises sensor data of the virtual objects and labels of the virtual objects.

12. The method of claim 1, wherein training the classification model by using the augmented scene and the label comprises:
modifying a simulated classification model by using the augmentation scene and the label, wherein the simulated classification model has been trained by using the simulated scene.

13. The method of claim 1, further comprising:
validating an accuracy of the classification model in classifying objects in the category of the augmentation object.

14. The method of claim 13, wherein validating the accuracy of the classification model in classifying objects in a category of the augmentation object comprises:
determining a precision or recall of the classification model in classifying objects in the category of the augmentation object.

15. The method of claim 13, wherein validating the accuracy of the classification model in classifying objects in the category of the augmentation object comprises:
determining whether an accuracy of the real-world classification model in classifying objects in the category of the augmentation object is better than the accuracy of the classification model in classifying objects in the category of the augmentation object.

16. The method of claim 13, wherein validating the accuracy of the classification model in classifying objects in the category of the augmentation object comprises:
generating validation objects in the category of the augmentation object;
updating the augmented scene by placing the validation objects into the augmented scene; and
validating the accuracy of the classification model by using the updated augmented scene.

17. The method of claim 1, wherein the first real-world scene and second real-world scene are a same real-world scene.

18. The method of claim 1, wherein the classification model is trained to receive sensor data generated by the vehicle and to output classifications of objects.

19. One or more non-transitory computer-readable media storing instructions executable to perform operations for training a classification model, the operations comprising:
accessing a simulated scene that simulates a first real-world scene;
generating an augmentation object based on a performance of a real-world classification model, the real-world classification model trained by using data collected from a second real-world scene;
generating an augmented scene by placing the augmentation object into the simulated scene;
generating a label of the augmentation object, the label describing a category of the augmentation object; and
training the classification model by using the augmented scene and the label of the augmentation object, the classification model to be used by a vehicle to classify objects surrounding the vehicle during an operation of the vehicle.

20. A computer-implemented system for training a classification model, the computer-implemented system comprising:
a processor; and
one or more non-transitory computer-readable media storing instructions, when executed by the processor, cause the processor to perform operations comprising:
accessing a simulated scene that simulates a first real-world scene;
generating an augmentation object based on a performance of a real-world classification model, the real-world classification model trained by using data collected from a second real-world scene;
generating an augmented scene by placing the augmentation object into the simulated scene;
generating a label of the augmentation object, the label describing a category of the augmentation object; and
training the classification model by using the augmented scene and the label of the augmentation object, the classification model to be used by a vehicle to classify objects surrounding the vehicle during an operation of the vehicle.
